(19) United States
(12) Patent Application Publication
(10) Pub. No.: US 2021/0383464 A1
(43) Pub. Date: Dec. 9, 2021

(54) ELECTRONIC DEVICE AND METHOD FOR BIDDING QUEUE NUMBER BASED ON BLOCKCHAIN

(71) Applicant: HON HAI PRECISION INDUSTRY CO., LTD., New Taipei (TW)

(72) Inventor: SHIAW-HERNG LIU, New Taipei (TW)

(21) Appl. No.: 17/338,936

(22) Filed: Jun. 4, 2021

(30) Foreign Application Priority Data
Jun. 5, 2020 (CN) 202010504754.6

(51) Int. Cl. G06Q 30/08; G06Q 10/10; G06Q 20/38; G06Q 20/32; G06Q 20/40; H04L 9/32

(52) U.S. Cl. CPC G06Q 30/08; G06Q 10/10; G06Q 20/389; G06Q 20/322; H04L 9/3234; G06Q 20/326; G06Q 20/3829; H04L 9/32; G06Q 20/405

(57) ABSTRACT

A method for bidding a queue number based on a blockchain implemented in an electronic device. The method includes generating an intelligent contract according to a bidding rule. Receiving and issuing a queue number to be bid transmitted by a queue device, receiving a bid application of bid users transmitted by mobile devices, and calculating a bid code value of each bid user according to the queue number to be bid and the queue number of each bid user. Transmitting a bid token of each bid user from the user account address to an address of the intelligent contract, determining a bid winner of the queue number to be bid according to the bid token of each bid user by executing the intelligent contract, and storing the bid information into a block, the block being written into the blockchain.

### CROSS-REFERENCE TO RELATED APPLICATIONS

This application claims priority to Chinese Patent Application No. 202010504754.6 filed on Jun. 5, 2020, the contents of which are incorporated by reference herein.

### FIELD

The subject matter herein generally relates to blockchain, and particularly to an electronic device, method, and storage medium for bidding queue number based on blockchain.

### BACKGROUND

Customers wanting to see a doctor, or wanting their bank to handle banking business etc., need to obtain a number to wait in a queue to be served. If the number-calling process is undisclosed, the queue number may be useless or false, which results in a wrong sequence of transactions with doctors or banks, and is inconvenient to the customers.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of an application environment of an electronic device according to the present disclosure.

FIG. 2 is a block diagram of an embodiment of an electronic device according to the present disclosure.

FIG. 3 is a block diagram of an embodiment of a queue number bidding system according to the present disclosure.

FIG. 4 illustrates a flowchart of an embodiment of a method for bidding a queue number based on a blockchain according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the presented disclosure.

The presented disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

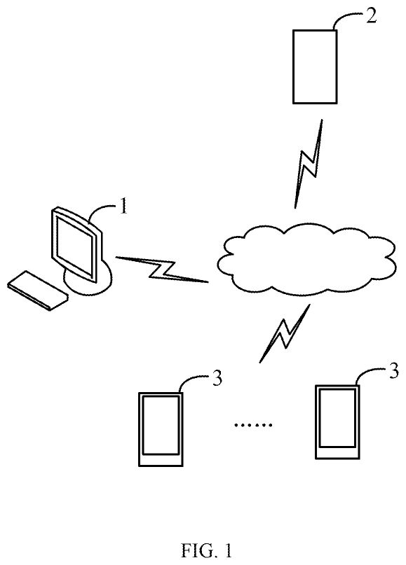

Referring to FIG. 1, an electronic device (electronic device 1) can communicate with a queue device 2 and at least one mobile device 3 through a network. In one embodiment, the network can be wired network or wireless network. The wireless network can be radio, WI-FI, cellular, satellite, broadcast, etc.

The electronic device 1 can further communicate with the mobile device 3 through a wireless network. In one embodiment, the wireless network can be radio, WI-FI, or cellular network.

In one embodiment, the electronic device 1 can be a personal computer, a server, and the like, the server can be a single server, a server cluster, or a cloud server.

In one embodiment, the queue device 2 can be a personal computer, configured to generate a queue number in response to a request from a user, and transmit the generated queue number to the mobile device 3 of the user. The queue device 2 at least includes a speaker 201 and a display screen 202. The speaker 201 can call out the queue number audibly. The display screen 202 can display the called-out queue number.

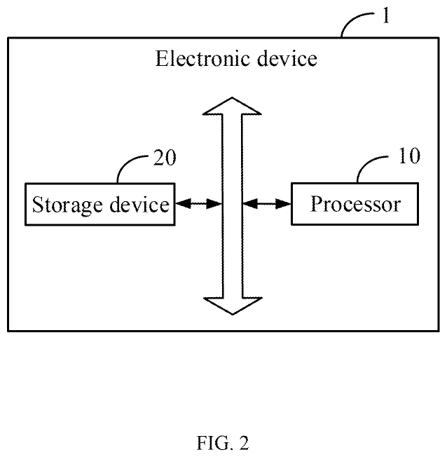

FIG. 2 illustrates the electronic device 1 in one embodiment. The electronic device 1 includes, but is not limited to, a processor 10 and a storage device 20. FIG. 2 illustrates only one example of the electronic device 1. Other examples can include more or fewer components than as illustrated or have a different configuration of the various components in other embodiments.

The processor 10 can be a central processing unit (CPU), a microprocessor, or other data processor chip that performs functions in the electronic device 1.

In one embodiment, the storage device 20 can include various types of non-transitory computer-readable storage mediums. For example, the storage device 20 can be an internal storage system, such as a flash memory, a random access memory (RAM) for the temporary storage of information, and/or a read-only memory (ROM) for permanent storage of information. The storage device 20 can also be an external storage system, such as a hard disk, a storage card, or a data storage medium.

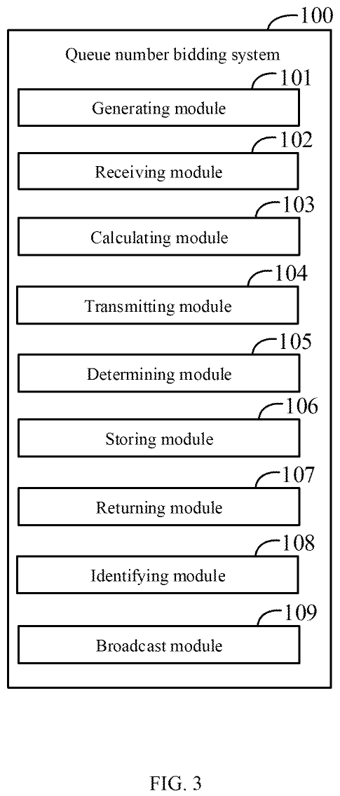

As illustrated in FIG. 3, the electronic device 1 runs a queue number bidding system 100. The queue number bidding system 100 at least includes a generating module 101, a receiving module 102, a calculating module 103, a transmitting module 104, a determining module 105, a storage module 106, a returning module 107, an identifying module 108, and a broadcast module 109. The modules 101-109 can be collections of software instructions stored in the storage device 20 of the electronic device 1 and executed by the processor 10. The modules 101-109 also can include functionality represented by hardware or integrated circuits, or by software and hardware combinations, such as a special-purpose processor or a general-purpose processor with special-purpose firmware.

The generating module 101 is used to generate an intelligent contract according to a bidding rule of queue numbers.

In one embodiment, the intelligent contract can be a segment of program code stored and run on a blockchain network. The intelligent contract is an activity rule and a relevant contract participating in common acknowledgement of a relevant party of a certain activity, and these rules and contracts are in code and placed in the blockchain network for execution. The intelligent contract allows for trustworthy transactions without a third party, such transactions are irreversible and can be tracked.

In one embodiment, the bidding rule is that a queue number of a bid user is greater than or equal to a queue number to be bid, and a bid user with a minimum bid token is determined to be the bid winner. That is, the content of the intelligent contract includes the queue number associated with the bid user greater than or equal to the queue number to be bid, and a bid user with the minimum bid token being determined to be the bid winner. The queue number associated with the bid user is equal to a number bid by the bid user. The bid users are users who participate in the bidding of a queue number.

The receiving module 102 is used to receive the queue number to be bid transmitted by the queue device 2.

In one embodiment, when there is no response to a callout of the queue number, the queue device 2 transmits the queue number without response to the electronic device 1. The receiving module 102 receives the queue number without response, determines the queue number without response to be the queue number to be bid, and transmits the queue number to be bid to the mobile devices 3 of the users who are currently queuing.

The receiving module 102 is further used to receive bid applications of the bid users transmitted by a number of mobile devices 3.

In one embodiment, the bid application at least includes the queue number and a public key of the bid user. The public key can be generated based on a private key of the mobile device 3 of the bid user by an encryption algorithm, and the bid application can be encrypted using the public key. The receiving module 102 decrypts the bid application using the public key to obtain the queue number of the bid user.

The calculating module 103 is used to calculate a bid code value of each bid user according to the queue number to be bid and the queue number of each bid user.

In one embodiment, the bid code value=queue number−queue number to be bid+1, the bid users are the users who send the bid application by the mobile devices 3. For example, if the queue number of the bid user is 20, and the queue number to be bid is 12, thus, the bid code value is 9.

The transmitting module 104 is used to transmit a bid token of each bid user from a user account address to an address of the intelligent contract.

In one embodiment, the user account address can be a network address of the user account in the blockchain, and the address of the intelligent contract can be a network address of the intelligent contract in the blockchain.

In one embodiment, the calculating module 103 further transmits the bid code value of each bid user to each of the mobile devices 3 corresponding to the bid user. The mobile device 3 of the bid user receives the bid code value and converts the received bid code value into the bid token according to a predefined rule.

In one embodiment, the predefined rule can be that an amount of the bid token is equal to the bid code value. For example, if the bid code value is 9, the bid token is 9 yen. In other embodiments, the predefined rule can also be that the bid token is member points which are equal to the bid code value. For example, if the bid code value is 9, the bid token is 9 member points.

The determining module 105 is used to determine the bid winner according to the bid token of each bid user by executing the intelligent contract.

In one embodiment, according to the intelligent contract, the determining module 105 determines the user having the minimum bid token to be the bid winner. For example, if the bid token of user A is 9 yen and the bid token of user B is 31 yen, the determining module 105 determines user A to be the bid winner. In one embodiment, the bid token is determined according to the queue number of the bid user, the smaller is the queue number, the smaller is the bid token, the bid user who provides the minimum bid token has the minimum queue number.

The storing module 106 is used to store the bid information into a block, and write the block into the blockchain.

In one embodiment, the block is written into the blockchain through a common recognition mechanism. The bid information includes the intelligent contract, the queue number to be bid, account information of the bid users, the bid code value of each bid user, and a bid result. The storing module 106 encrypts the bid information, packages the bid information into the block, and writes the block into the blockchain.

The transmitting module 104 is further used to transmit the bid result to the mobile device 3 of the bid winner.

The returning module 107 is used to return the bid token of the bid losers to the account addresses of the bid losers. In one embodiment, the bid losers are the bid users other than the bid winner.

The transmitting module 104 is further used to control the queue device 2 to call out the queue number of the bid winner.

In one embodiment, the transmitting module 104 controls the queue device 2 to call out the queue number of the bid winner by transmitting a control instruction, the control instruction at least includes the queue number of the bid winner. When receiving the control instruction, the queue device 2 obtains the queue number and calls out the queue number of the bid winner.

The identifying module 108 is used to identify the queue number, the blockchain address, and the private key from the mobile device 3 of a user who responds to the call-out queue number.

In one embodiment, the bit address of the blockchain is generated by encrypting the public key of the mobile device 3. In detail, a hash value of the public key can be calculated by performing a SHA256 algorithm on the public key, the blockchain address can be determined by processing the hash value according to Hash160 and Base58, a length of the blockchain address can be 25 bytes.

In one embodiment, if the queue number from the mobile device 3 is the same as the call-out queue number, the blockchain address from the mobile device 3 is the same as a bit address determined by the public key within the bid application of the user, and a public key determined by the private key is the same as the public key within the bid application of the user, the identifying module 108 determines that the queue number, the blockchain address, and the private key from the mobile device 3 are valid, and further determines that the user is the bid winner, and the user can proceed with the transaction by his/her queue number. If the queue number from the mobile device 3 is not the same as the call-out queue number, and/or the blockchain address from the mobile device 3 is not the same as the bit address determined by the public key within the bid application of the user, and/or the public key determined by the private key is not the same as the public key within the bid application of the user, the identifying module 108 determines that the queue number, the blockchain address, and the private key from the mobile device 3 are not valid, and further determines that the user is not the bid winner, and the user cannot proceed with the transaction.

The broadcasting module 109 is used to broadcast the bid information.

In one embodiment, the broadcasting module 109 transmits the bid information to the mobile device 3 of each bid user on the blockchain, so as to broadcast the bid information.

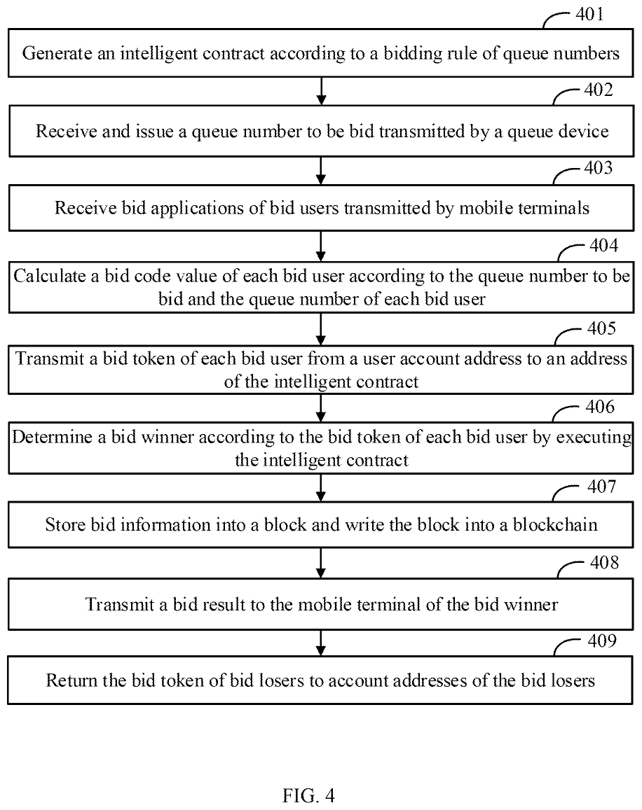

FIG. 4 illustrates a flowchart of an embodiment of a method for bidding a queue number based on a blockchain. The method is provided by way of example, as there are a variety of ways to carry out the method. The method described below can be carried out using the configurations illustrated in FIGS. 1-3, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401.

At block 401, the generating module 101 generates an intelligent contract according to a bidding rule of queue numbers.

In one embodiment, the intelligent contract can be a segment of program code stored and run on a blockchain network. The intelligent contract is an activity rule and a relevant contract participating in common acknowledgement of a relevant party of a certain activity, and these rules and contracts are in code and placed in the blockchain network for execution. The intelligent contract allows for trustworthy transactions without a third party, such transactions are irreversible and can be tracked.

In one embodiment, the bidding rule is that a queue number of a bid user is greater than or equal to a queue number to be bid, and a bid user with a minimum bid token is determined to be the bid winner. That is, the content of the intelligent contract includes the queue number associated with the bid user greater than or equal to the queue number to be bid, and a bid user with the minimum bid token being determined to be the bid winner. The queue number associated with the bid user is equal to a number bid by the bid user.

At block 402, the receiving module 102 receives and issues the queue number to be bid transmitted by the queue device 2.

In one embodiment, when there is no response to a callout of the queue number, the queue device 2 transmits the queue number without response to the electronic device 1. The receiving module 102 receives the queue number without response, determines the queue number without response to be the queue number to be bid, and transmits the queue number to be bid to the mobile devices 3 of the users who are currently queuing.

At block 403, the receiving module 102 further receives bid applications of the bid users transmitted by a number of mobile devices 3.

In one embodiment, the bid application at least includes the queue number and a public key of the bid user. The public key can be generated based on a private key of the mobile device 3 of the bid user by an encryption algorithm, and the bid application can be encrypted using the public key. The receiving module 102 decrypts the bid application using the public key to obtain the queue number of the bid user.

At block 404, the calculating module 103 calculates a bid code value of each bid user according to the queue number to be bid and the queue number of each bid user.

In one embodiment, the bid code value=queue number−queue number to be bid+1, the bid users are the users who send the bid application by the mobile devices 3. For example, if the queue number of the bid user is 20, and the queue number to be bid is 12, thus, the bid code value is 9.

At block 405, the transmitting module 104 transmits a bid token of each bid user from a user account address to an address of the intelligent contract.

In one embodiment, the user account address can be a network address of the user account in the blockchain, and the address of the intelligent contract can be a network address of the intelligent contract in the blockchain.

In one embodiment, the calculating module 103 further transmits the bid code value of each bid user to each of the mobile devices 3 corresponding to the bid user. The mobile device 3 of the bid user receives the bid code value and converts the received bid code value into the bid token according to a predefined rule.

In one embodiment, the predefined rule can be that an amount of the bid token is equal to the bid code value. For example, if the bid code value is 9, the bid token is 9 yen. In other embodiments, the predefined rule can also be that the bid token is member points which are equal to the bid code value. For example, if the bid code value is 9, the bid token is 9 member points.

At block 406, the determining module 105 determines the bid winner according to the bid token of each bid user by executing the intelligent contract.

In one embodiment, according to the intelligent contract, the determining module 105 determines the user having the minimum bid token to be the bid winner. For example, if the bid token of user A is 9 yen and the bid token of user B is 31 yen, the determining module 105 determines user A to be the bid winner. In one embodiment, the bid token is determined according to the queue number of the bid user, the smaller is the queue number, the smaller is the bid token, the bid user who provides the minimum bid token has the minimum queue number.

At block 407, the storing module 106 stores the bid information into a block, and writes the block into the blockchain.

In one embodiment, the block is written into the blockchain through a common recognition mechanism. The bid information includes the intelligent contract, the queue number to be bid, account information of the bid users, the bid code value of each bid user, and a bid result. The storing module 106 encrypts the bid information, packages the bid information into the block, and writes the block into the blockchain.

At block 408, the transmitting module 104 further transmits the bid result to the mobile device 3 of the bid winner.

At block 409, the returning module 107 returns the bid token of the bid losers to the account addresses of the bid losers. In one embodiment, the bid losers are the bid users other than the bid winner.

The method further includes: the transmitting module 104 controls the queue device 2 to call out the queue number of the bid winner.

In one embodiment, the transmitting module 104 controls the queue device 2 to call out the queue number of the bid winner by transmitting a control instruction, the control instruction at least includes the queue number of the bid winner. When receiving the control instruction, the queue device 2 obtains the queue number and calls out the queue number of the bid winner.

The method further includes: the identifying module 108 identifies the queue number, the blockchain address, and the private key from the mobile device 3 of a user who responds to the call-out queue number.

In one embodiment, the bit address of the blockchain is generated by encrypting the public key of the mobile device 3. In detail, a hash value of the public key can be calculated by performing a SHA256 algorithm on the public key, the blockchain address can be determined by processing the hash value according to Hash160 and Base58, a length of the blockchain address can be 25 bytes.

In one embodiment, if the queue number from the mobile device 3 is the same as the call-out queue number, the blockchain address from the mobile device 3 is the same as a bit address determined by the public key within the bid application of the user, and a public key determined by the private key is the same as the public key within the bid application of the user, the identifying module 108 determines that the queue number, the blockchain address, and the private key from the mobile device 3 are valid. If the queue number from the mobile device 3 is not the same as the call-out queue number, and/or the blockchain address from the mobile device 3 is not the same as the bit address determined by the public key within the bid application of the user, and/or the public key determined by the private key is not the same as the public key within the bid application of the user, the identifying module 108 determines that the queue number, the blockchain address, and the private key from the mobile device 3 are not valid, and further determines that the user is not the bid winner, and the user cannot proceed with the transaction.

The method further includes: the broadcasting module 109 broadcasts the bid information.

In one embodiment, the broadcasting module 109 transmits the bid information to the mobile device 3 of each bid user on the blockchain, so as to broadcast the bid information.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
at least one processor; and
a storage device coupled to the at least one processor and storing instructions for execution by the at least one processor to cause the at least one processor to:
generate an intelligent contract according to a bidding rule of queue numbers;
receive and issue a queue number to be bid transmitted by a queue device of the electronic device;
receive bid applications of bid users transmitted by a plurality of mobile devices;
calculate a bid code value of each of the bid users according to the queue number to be bid and the queue number associated with each of the bid users;
transmit a bid token of each of the bid users from a user account address to an address of the intelligent contract;
determine a bid winner according to the bid token of each of the bid users by executing the intelligent contract; and
store bid information into a block and write the block into a blockchain.

2. The electronic device according to claim 1, wherein the bid information comprises the intelligent contract, the queue number to be bid, account information of the bid users, the bid code value of each of the bid users, and a bid result.

3. The electronic device according to claim 1, wherein the at least one processor is further caused to:
transmit a bid result to the mobile device of the bid winner; and
broadcast the bid information.

4. The electronic device according to claim 1, wherein the at least one processor is further caused to:
transmit the bid code value of each of the bid users to the mobile device of the bid user;
convert the bid code value into the bid token according to a predefined rule; and
return the bid token of each of bid losers to the user account address of each of bid losers.

5. The electronic device according to claim 1, wherein content of the intelligent contract comprises the queue number associated with each of the bid users greater than or equal to the queue number to be bid, and a bid user with a minimum bid token being determined to be the bid winner.

6. The electronic device according to claim 1, wherein the at least one processor is further caused to:
control the queue device to call out the queue number of the bid winner according to a bid result by transmitting a control instruction.

7. The electronic device according to claim 6, wherein the at least one processor is further caused to:
identify the queue number, a blockchain address, and a private key from a mobile device of a user who responds to the call-out queue number.

8. The electronic device according to claim 7, wherein the bid application comprises a public key, the at least one processor is further caused to:
determine, in response that the queue number from the mobile device is the same as the call-out queue number, the blockchain address from the mobile device is the same as a bit address determined by the public key within the bid application of the user, and a public key determined by the private key is the same as the public key within the bid application of the user, that the queue number, the blockchain address, and the private key from the mobile device are valid.

9. A method for bidding a queue number based on a blockchain implemented in an electronic device comprising:
generating an intelligent contract according to a bidding rule of queue numbers;
receiving and issuing a queue number to be bid transmitted by a queue device of the electronic device;
receiving bid applications of bid users transmitted by a plurality of mobile devices;
calculating a bid code value of each of the bid users according to the queue number to be bid and the queue number associated with each of the bid users;
transmitting a bid token of each of the bid users from a user account address to an address of the intelligent contract;
determining a bid winner according to the bid token of each of the bid users by executing the intelligent contract; and
storing bid information into a block and writing the block into a blockchain.

10. The method according to claim 9, wherein the bid information comprises the intelligent contract, the queue number to be bid, account information of the bid users, the bid code value of each of the bid users, and a bid result.

11. The method according to claim 9, further comprising:
transmitting a bid result to the mobile device of the bid winner; and
broadcasting the bid information.

12. The method according to claim 9, further comprising:
transmitting the bid code value of each of the bid users to the mobile device of the bid user;
converting the bid code value into the bid token according to a predefined rule; and
returning the bid token of each of bid losers to the user account address of each of bid losers.

13. The method according to claim 9, wherein content of the intelligent contract comprises the queue number associated with each of the bid users greater than or equal to the queue number to be bid, and a bid user with a minimum bid token being determined to be the bid winner.

14. The method according to claim 9, further comprising:
controlling the queue device to call out the queue number of the bid winner according to a bid result by transmitting a control instruction.

15. The method according to claim 14, further comprising:
identifying the queue number, a blockchain address, and a private key from a mobile device of a user who responds to the call-out queue number.

16. The method according to claim 15, further comprising:
determining, in response that the queue number from the mobile device is the same as the call-out queue number, the blockchain address from the mobile device is the same as a bit address determined by the public key within the bid application of the user, and a public key determined by the private key is the same as the public key within the bid application of the user, that the queue number, the blockchain address, and the private key from the mobile device are valid.
